(19) United States
(12) Patent Application Publication
(10) Pub. No.: US 2019/0130699 A1
(43) Pub. Date: May 2, 2019

(54) Wagering Game Award System for Cross-Store Wagering

(71) Applicant: Bingotimes Digital Technology Co., Ltd., Taichung City (TW)

(72) Inventor: CHIH-TSUNG LO, Taichung City (TW)

(21) Appl. No.: 15/801,299

(22) Filed: Nov. 1, 2017

(51) Int. Cl. G07F 17/32

(52) U.S. Cl. CPC G07F 17/3244; G07F 17/3272; G07F 17/3211; G07F 17/3288; G07F 17/3223

(57) ABSTRACT

A wagering game award system for cross-store wagering includes at least two store operating units. Each store operating unit includes a first computer, a second computer, and a third computer. The first computer includes a player information verification unit and a wager feedback program, and is connected with a plurality of player machines. Each player machine can display a player operation interface. The second computer is connected with at least one game machine. The second computer is connected with the third computer of the other store operating unit. The player operation interface includes a player login field, a main game field, and a cross-store game selection field. The wager feedback program sets a wager amount range and judges whether or not the total wager amount of a player is eligible for feedback award. If eligible, the player operation interface displays a feedback award menu.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a wagering game award system for cross-store wagering, and more particularly to a wagering game award system which can encourage the players to increase the wager amount and provide the actual feedback to the players and improve the store's revenue.

### Description of Related Arts

As shown in FIG. 1, a conventional wagering game award system comprises a control device 10. The control device 10 has built-in wager feedback program and is connected with a network device 11 of each store via the Internet. The network device 11 is connected with each game machine 12 and each display 13 of the store, so that the control device 10 can obtain the consumption amount of all the stores and the usage status of each game machine 12 through the network device 11 of each store. A portion of the consumption amount serves as the feedback award. The wager feedback program is set with at least one wager amount range in the control device 10. A number within the range is randomly drawn as the wager feedback award. Since the control device 10 sequentially acquires the consumption amount of each game machine 12, each consumption amount is calculated and accumulated into the cumulative consumption amount. When the current cumulative consumption amount reaches the wager feedback amount, the player of the game machine 12 of this consumption amount can get the wager feedback amount, thereby attracting the players to increase the wager amount. However, the wager feedback has the following shortcomings.

1. It is necessary to accumulate the consumption amount for wager feedback, that is, it is necessary to accumulate the wagers of many payers for generating the wager feedback. The player who is familiar with the rules of the game will not wager for a long time in order to win the wager feedback, or may wager a small amount on the game and pay attention to the cumulative consumption amount whether or not to reach the standard. The wager feedback game no longer attracts the players familiar with the game to wager.

2. There are many cross-store games on the market. However, every player has his/her favorite games. If the player feels his/her luck is not in, he/she may end the game today and play the game another day. As a result, the store's revenue decreases.

Accordingly, the inventor of the present invention has devoted himself based on his many years of practical experiences to solve these problems.

### SUMMARY OF THE PRESENT INVENTION

The primary object of the present invention is to solve the aforesaid problems and to provide a wagering game award system for cross-store wagering. The system comprises at least two store operating units connected by the Internet. The wagering time, the drawing time and the settlement time of the game machines of the store operating units are synchronous, so that players can simultaneously make the wagers with the game machines of the store operating units. Each store operating unit has a wager feedback program. The wager feedback program sets a total wager amount range for starting the feedback award, and counts and calculates the total wager amount of each player to the store operating units within the wagering time. The wager feedback program judges whether the total wager amount of a player is eligible for the feedback award. If eligible, the player operation interface displays a feedback award menu for the player to choose a wager feedback mode. The options of the feedback mode contain a wager feedback, a winning feedback, a losing feedback, and a getting feedback.

In order to achieve the aforesaid object, the wagering game award system for cross-store wagering of the present invention comprises at least two store operating units. Each of the store operating units comprises a first computer, a second computer, and a third computer. The first computer includes a player information verification unit and a wager feedback program. The first computer is connected with a plurality of player machines. The second computer is connected with the first computer. The second computer is further connected with at least one game machine. The third computer is connected with the first computer. The third computer includes an authentication unit. The authentication unit authenticates whether or not the game machine is allowed to connect. The second computer is connected with the third computer of the other store operating unit via Internet. The first computer generates a player operation interface on each of the player machines. The player operation interface includes a player login field, a main game field, and a cross-store game selection field. The wager feedback program sets a wager amount range and judges whether or not the total wager amount of a player is eligible for feedback award. If eligible, the player operation interface displays a feedback award menu. The feedback award menu contains options of a wager feedback, a winning feedback, a losing feedback, and a getting feedback. The above-mentioned system can encourage the players to increase the wager amount and provide the actual feedback to the players and improve the store's revenue.

In an embodiment of the present invention, the wager feedback program is set with a weighted ratio of feedback. A corresponding one of the options of the feedback award menu is multiplied by the weighted ratio to score. The weighted ratio of the wager feedback is greater than zero and less than or equal to five thousandths. The weighted ratio of the winning feedback is greater than zero and less than or equal to twelve thousandths. The weighted ratio of the losing feedback is greater than zero and less than or equal to twelve thousandths. The weighted ratio of the getting feedback is greater than zero and less than or equal to twelve thousandths.

In an embodiment of the present invention, the third computer receives game information of the game machine of the other store operating unit and supplies the cross-store game selection field of the player operation interface to the player machines of the first computer.

In an embodiment of the present invention, the game information includes a wagering time, a drawing time, a settlement time, and a drawing result of the game machine of each of the store operating units.

In an embodiment of the present invention, the wagering time, the drawing time and the settlement time of the game machines of the store operating units are synchronous.

In an embodiment of the present invention, the wager feedback program counts and calculates the total wager amount of the player to the store operating units each round.

In an embodiment of the present invention, the game machines include a display device, an input device, and a remote control device. The display device generates the player operation interface.

The above-mentioned system can encourage the players to increase the wager amount and provide the actual feedback to the players and improve the store's revenue.

### BRIEF DESCRIPTION OF THE DRAWINGS

FIG. 1 is a schematic view of a conventional system;

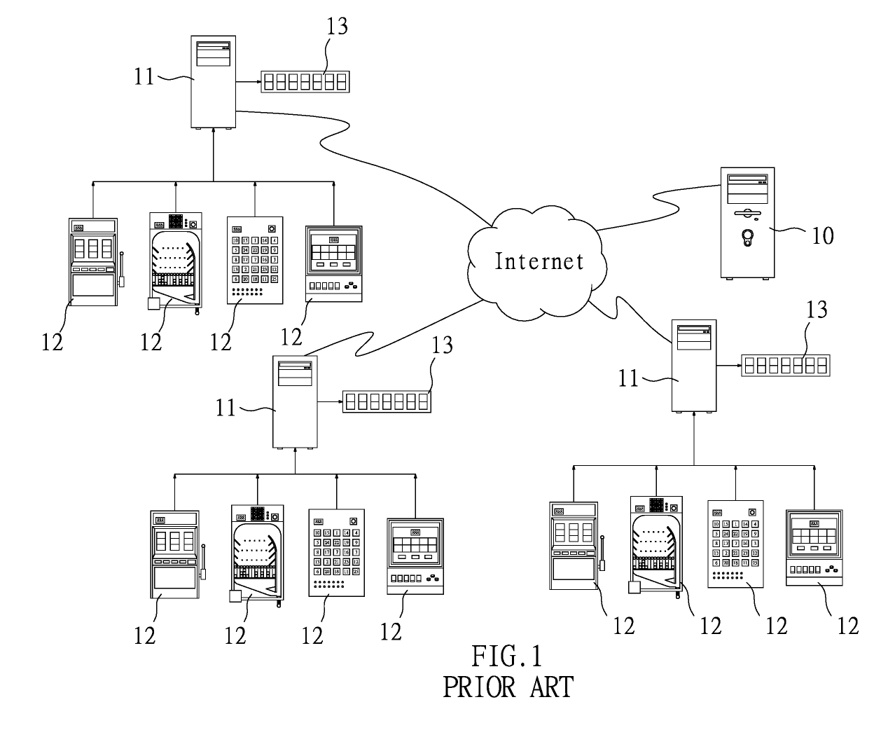

FIG. 2 is a schematic view of the system of the present invention;

FIG. 3 is a block diagram of the game machine of the present invention;

FIG. 4 is a block diagram of the player operation interface of the present invention;

FIG. 5 is a block diagram of the feedback award menu of the present invention; and

FIG. 6 is a flowchart showing the steps of the player login of the present invention.

### DETAILED DESCRIPTION OF THE PREFERRED EMBODIMENT

Embodiments of the present invention will now be described, by way of example only, with reference to the accompanying drawings.

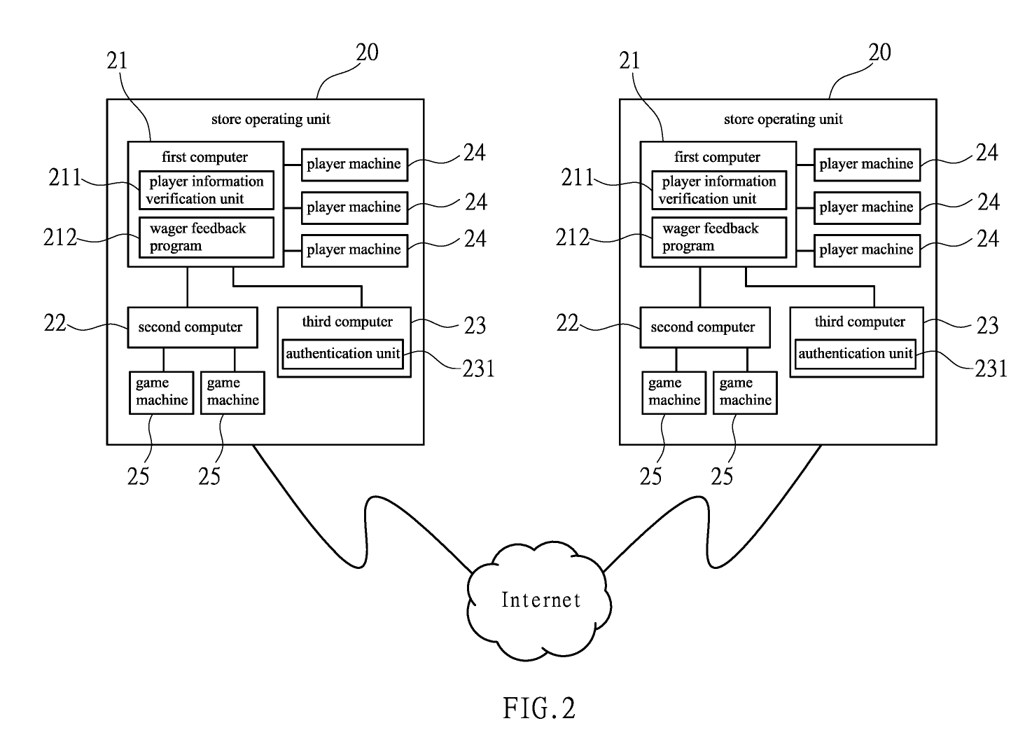

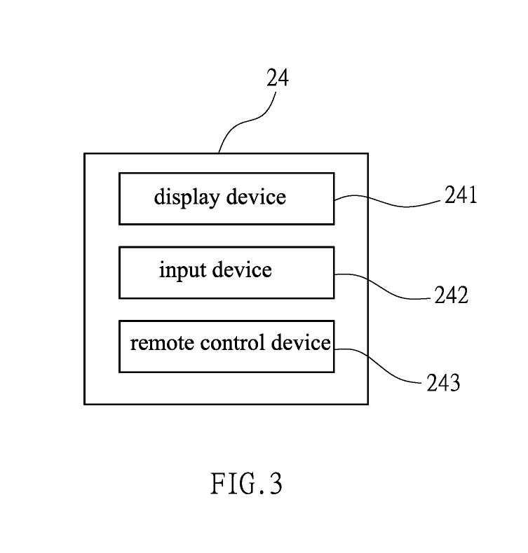

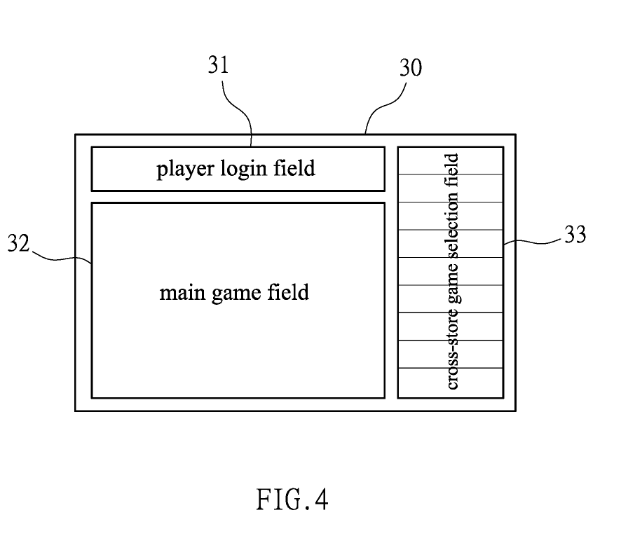

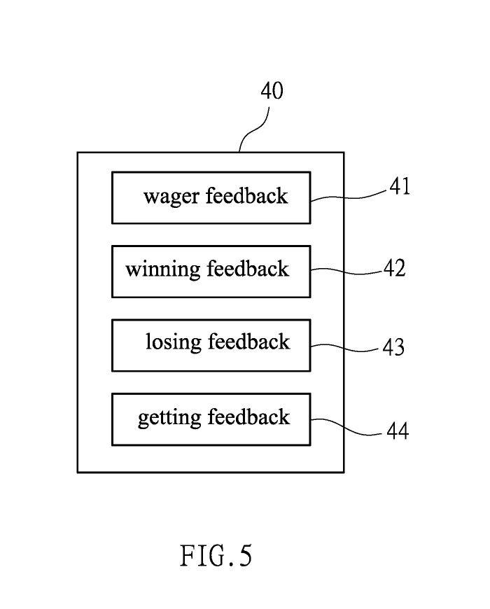

Referring to FIG. 2 to FIG. 6, the present invention provides a wagering game award system for cross-store wagering. The wagering game award system comprises at least two store operating units 20. Each store operating unit 20 comprises a first computer 21, a second computer 22, and a third computer 23. The first computer 21 includes a player information verification unit 211 and a wager feedback program 212. The first computer 21 is further connected with a plurality of player machines 24. The player machines 24 include a display device 241, an input device 242, and a remote control device 243. The second computer 22 is connected with the first computer 21. The second computer 22 is further connected with at least one game machine 25. The third computer 23 is connected with the first computer 21. The third computer 23 includes an authentication unit 231. The authentication unit 231 authenticates whether or not the game machine 25 is allowed to connect. The second computer 22 is connected with the third computer 23 of the other store operating unit 20 via the Internet. The first computer 21 may generate a player operation interface 30 on the display device 241 of each player machine 24. The player operation interface 30 includes a player login field 31, a main game field 32, and a cross-store game selection field 33. The wager feedback program 212 sets a wager amount range and judges whether or not the player's total wager amount is eligible for the feedback award. If it is eligible, the player operation interface 30 displays a feedback award menu 40. The feedback award menu 40 contains options of a wager feedback 41, a winning feedback 42, a losing feedback 43, and a getting feedback 44. By the system, the players may increase the wager amount to get the real feedback, having the effect of encouraging the players to wager and increasing the store's revenue.

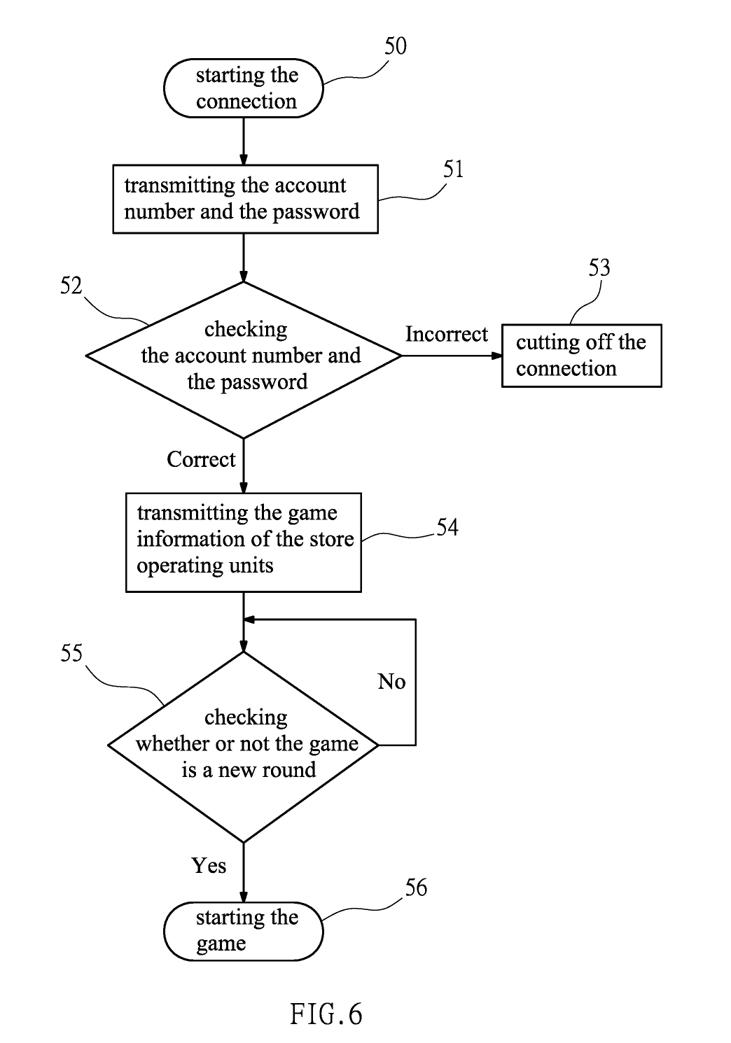

The assembly, functions and details of the above-described embodiment are described below. Referring to FIG. 2 to FIG. 6, the second computer 22 of each store operating unit 20 is connected with the third computers 23 of the other store operating units 20 via the Internet. The authentication unit 231 of each third computer 23 authenticates the communication protocol of the game machine 25 of each second computer 22 and determines whether a connection is permitted, or through an authentication code to avoid a connection that does not conform to the communication protocol. After authenticated as a matching communication protocol, each third computer 23 receives the game information of the game machine 25 of the other remote store operating unit 20 and supplies the information to the first computer 21. In other words, each third computer 23 can copy and transmit the game information of the game machine 25 of the other store operating unit 20 and can avoid a connection of a non-eligible communication protocol. The player transmits the player's account and password through the input device 242 or the remote control device 243 to the player information verification unit 211 of the first computer 21 to perform membership verification login. Preferably, the input device 242 may be a button or a keyboard. The remote control device 243 may be a hand-held electronic communication device, such as a mobile phone, a tablet, and the like, to connect with the player machine 24 by means of Bluetooth. FIG. 6 is a flowchart showing the steps of the player login. After Step 50, starting a connection. The player login field 31 of the player operation interface 30 is inputted with the account number and the password. Step 51, the player operation interface 30 transmits the account number and the password to the player information verification unit 211. Step 52, the player information verification unit 211 checks the account number and the password. Step 53, if the account number and the password are incorrect, the connection is cut off. If the account number and the password are incorrect, the first computer 21 transmits the game information of the second computer of the store to the main game field 32 of the player operation interface 30, and Step 54, the game information of the other store operating units 20 is transmitted to the cross-store game selection field 33 of the player operation interface 30. The game information includes the wagering time, the drawing time, the settlement time, and the drawing result of the game machine 25 of each of the store operating units 20. The wagering time, the drawing time, and the settlement time of the game machines 25 are synchronous. The wagering time of each store operating unit 20 has no time difference. All the game machines 25 of each store operating unit 20 are started, wagered, drawn and settled at the same time. Next, Step 55, the player machines 24 check whether or not the game of the game machine 25 of the store operating unit 20 is a new round, If not, waiting; if yes, Step 56, the game starts. The display devices 241 of the player machines 24 of each of the store operating units 20 can simultaneously display the game information of the game machines 25 of all the store operating unit units 20, including whether or not there is a new round, whether it is a wagering time, whether or not it is the time for drawing, the drawing result and the settlement result, so that the player machines 24 of one of the store operating units 20 has the game information of the other store operating units 20. Further, if the game machines 25 of the different store operating units 20 have the same game, and the game needs to cooperate with a physical response device as the drawing result. The drawing result of the physical response device may be simultaneously displayed to other operating stores 20 having the same game as the drawing result of the other same game machines 25. Therefore, the game machines 25 having the same game of the store operating units 20 require only one physical response device. The drawing result can be transmitted to the third computer 23 of each store operating unit 20 by using a video apparatus provided on the second computer 22, having a fair and impartial drawing result and saving the operating cost. Afterward, the player may wager on the main game field 32 of the player operation interface 30 and select the cross-store game selection field 33 for cross-store wagering. In this way, the player may wager on the game machine 25 of the store operating unit 20 at the beginning of each round of the game and wager on the game machine 25 of the other store operating units 20, and the wager feedback program 212 counts and calculates the total wager amount of the player to the store operating units 20 this round. The wagering time may be displayed in the countdown. The player can select the game machine 25 of the other store operating unit 20 within the wagering time through the cross-store game selection field 33 of the player operation interface 30, and the selected game machine 25 of the store operating unit 20 is switched to the main game field 32 for the player to select the wager. Preferably, the game machines 25 of the store operating units 20 may have the same game or different games for the players to select a desired one. After the wagering time is over, the game machines 25 are in the state of drawing time or the settlement time, so the players cannot wager. Since the player can connect with the different store operating units 20, the player may simultaneously make the wager to each store operating unit 20, thereby increasing the store's revenue. In addition, the wager feedback program 212 sets the wager amount range that can start the player feedback award. For example, the feedback amount range is set to equal to or greater than 5,000 points. In the wagering time of the game each round, if the total wager amount of the player is more than 5,000 points, the player feedback award is started. When the player is eligible for the feedback award, the player operation interface 30 jumps out of the feedback award menu 40 for the player to select a wager feedback mode. The wager feedback program 212 is set with a weighted ratio of feedback. Each of the store operating units 20 may independently set the weighted ratio. The weighted ratio of the wager feedback 41 is greater than zero and less than or equal to five thousandths. The weighted ratio of the winning feedback 42 is greater than zero and less than or equal to twelve thousandths. The weighted ratio of the losing feedback 43 is greater than zero and less than or equal to twelve thousandths. The weighted ratio of the getting feedback 44 is greater than zero and less than or equal to twelve thousandths. If the player chooses the option of the wager feedback 41, the feedback is the total wager amount of the player multiplied by greater than zero or less than or equal to five thousandths. If the player chooses the option of the wining feedback 42, the feedback is the total winning amount of the player multiplied by greater than zero or less than or equal to twelve thousandths. If the player chooses the option of the losing feedback 42, the feedback is the total losing amount of the player multiplied by greater than zero or less than or equal to twelve thousandths. If the player chooses the option of the getting feedback 42, the feedback is the total wager amount of the player deducting the total losing amount (namely, the actual winning amount) and multiplied by zero or less than or equal to twelve thousand. After the wagering time is over, the game machines 25 may be drawn at the same time. The player score is calculated based on the drawing result of the game machines 25. The feedback is calculated based on the wager feedback mode selected by the player to give the player. When the player has confidence in wagering, the player may choose the winning feedback 42 or the getting feedback 44 to give a bonus point on the winning score. When the player lacks confidence in wagering, the player may choose the losing feedback 43 to reduce the losing amount. The conservative player may choose the wager feedback 41 to get the actual feedback. This way can encourage the players to increase the wager amount and to wager at different stores for risk spreading. There is no need for the player to wait for the connection of each game machine 25 to accumulate the prize, having the substantial feedback.

As described above, the present invention has the following effects and advantages:

1. The feedback award does not have to accumulate the consumption amount of many players, so that the players need not take time to wait for the amount of the feedback award. Through the present invention, when the total wager amount reaches the feedback award range each round, the actual feedback is given, thereby encouraging the players to increase the wager amount.

2. The player can simultaneously make the wager to each store operating unit 20 at the same round within the wagering time, so that the players can spread the wagering risk through different drawing results of different stores having the same game, thereby increasing the player's wagering intension and increasing the store's revenue.

3. The store operating unit 20 can set the weighted ratio of feedback according to the local custom and the player's acceptance. The player can choose a desired store operating unit 20 for wagering, thereby attracting different players.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A wagering game award system for cross-store wagering, comprising at least two store operating units, each of the store operating units comprising a first computer, a second computer, and a third computer; the first computer including a player information verification unit and a wager feedback program, the first computer being connected with a plurality of player machines; the second computer being connected with the first computer, the second computer being further connected with at least one game machine; the third computer being connected with the first computer, the third computer including an authentication unit, the authentication unit authenticating whether or not the game machine is allowed to connect; the second computer being connected with the third computer of the other store operating unit via Internet, the first computer generating a player operation interface on each of the player machines, the player operation interface including a player login field, a main game field, and a cross-store game selection field; the wager feedback program setting a wager amount range and judging whether or not the total wager amount of a player is eligible for feedback award, if eligible, the player operation interface displaying a feedback award menu, the feedback award menu containing options of a wager feedback, a winning feedback, a losing feedback, and a getting feedback.

2. The wagering game award system for cross-store wagering as claimed in claim 1, wherein the wager feedback program is set with a weighted ratio of feedback, a corresponding one of the options of the feedback award menu is multiplied by the weighted ratio to score, the weighted ratio of the wager feedback is greater than zero and less than or equal to five thousandths, the weighted ratio of the winning feedback is greater than zero and less than or equal to twelve thousandths, the weighted ratio of the losing feedback is greater than zero and less than or equal to twelve thousandths, and the weighted ratio of the getting feedback is greater than zero and less than or equal to twelve thousandths.

3. The wagering game award system for cross-store wagering as claimed in claim 1, wherein the third computer receives game information of the game machine of the other store operating unit and supplies the cross-store game selection field of the player operation interface to the player machines of the first computer.

4. The wagering game award system for cross-store wagering as claimed in claim 3, wherein the game information includes a wagering time, a drawing time, a settlement time, and a drawing result of the game machine of each of the store operating units.

5. The wagering game award system for cross-store wagering as claimed in claim 4, wherein the wagering time, the drawing time and the settlement time of the game machines of the store operating units are synchronous.

6. The wagering game award system for cross-store wagering as claimed in claim 1, wherein the wager feedback program counts and calculates the total wager amount of the player to the store operating units each round.

7. The wagering game award system for cross-store wagering as claimed in claim 1, wherein the game machines include a display device, an input device and a remote control device, and the display device generates the player operation interface.
